(19) United States
(12) Patent Application Publication
(10) Pub. No.: US 2012/0222372 A1
(43) Pub. Date: Sep. 6, 2012

(54) ADJUSTING DEVICE OF A STATIONARY PHOTOVOLTAIC SYSTEM

(76) Inventor: Franz HILBER, Trins (AT)

(21) Appl. No.: 13/473,866

(22) Filed: May 17, 2012

Related U.S. Application Data
(63) Continuation of application No. PCT/AT2010/000441, filed on Nov. 16, 2010.

(30) Foreign Application Priority Data
Nov. 18, 2009 (AT) A 1823/2009
Nov. 18, 2009 (AT) A 1824/2009
Nov. 18, 2009 (AT) A 1825/2009

(51) Int. Cl. F16M 11/12; E02D 27/00; F24J 2/38; E02D 27/32

(52) U.S. Cl. 52/173.3; 52/741.15; 52/745.21; 248/122.1

(57) ABSTRACT

The invention relates to a support structure (4) for a stationary photovoltaic system (1), comprising a support part (30) which comprises securing points for a flat photovoltaic unit (2) and at least one drive device (31) for the driven adjustment of the support part (30) and at least one single-axis adjusting device (32) which can adjust a photovoltaic unit (2), secured to the support part (30), in azimuth (a) and elevation (h) about an adjustable axis (V1) between a setup position (35) and an end position (36). The projection of the surface normals (n) of the photovoltaic-unit (2) on the horizontal plane in the setup position (35) defines a setup axis (E) and the projection of the adjusting axis (V1) on the horizontal plane defines a projected adjusting axis (P1), the projected adjusting axis (P1) to the setup axis (E) forming an angle (EP1) in the region of more than 5 degrees and less than 80 degrees, preferably in the region of more than 10 degrees and less than 60 degrees.

The invention relates to a support structure for a stationary photovoltaic system, with a support part, which has securing points for a flat photovoltaic unit and at least one drive device for the driven adjustment of the support part and at least one single-axis adjusting device, by means of which a photovoltaic unit secured to the support part can be adjusted in azimuth and elevation about an adjusting axis between a setup position and an end position, wherein the projection of the surface normals of the photovoltaic unit on the horizontal plane in the setup position defines a setup axis and the projection of the adjusting axis on the horizontal plane defines a projected adjusting axis.

In general, photovoltaic systems are set up in such a way that the collecting surface of the photovoltaic unit is oriented towards the south in an initial position. A deviation of the orientation from the south towards the west is designated as positive azimuth +a, a deviation towards the east as negative azimuth −a. Exact orientation of the photovoltaic unit towards the south is designated as azimuth a=0.

Elevation, in photovoltaic technology, denotes the angle of inclination that the collecting surface of the photovoltaic unit forms with the horizontal plane. The initial position of the photovoltaic unit of a photovoltaic system is usually selected in such a way that it is in north-south orientation, i.e. at azimuth a=0, and has an elevation hₘᵢₙ—i.e. an ideal angle of inclination relative to the sun. As a rule, adjustment of the photovoltaic unit takes place starting from this initial position.

Such support structures for stationary photovoltaic systems that are adjustable with a drive device are sufficiently well known from the state of the art.

A more economical variant is implemented with just one single-axis adjusting device, by means of which the photovoltaic unit is adjusted in its angle of inclination and in its azimuth orientation in such a way that it essentially tracks the sun. The drawback with these single-axis adjusting devices is that tracking of the position of the sun can only take place to a limited extent. With two-axis adjusting devices, in which normally the second axis essentially forms a 90° angle with the first adjusting axis, tracking of the position of the sun can be more accurate, but this is associated with increased costs, through the use of a second drive or by using just one drive and an additional transmission system.

The problem to be solved by the invention is to avoid the drawbacks described above and provide a support structure for a stationary photovoltaic system that is improved relative to the state of the art.

This is achieved in the support structure according to the invention in that the projected adjusting axis forms an angle with the setup axis in the range of more than 5 degrees and less than 80 degrees, preferably in the range of more than 10 degrees and less than 60 degrees.

Thus, the projected adjusting axis deviates from the setup axis, with the result that swivelling does not take place about an imaginary central axis of the photovoltaic unit, but swivelling proceeds along an axis that deviates from this central axis. A further result is that the ends of the photovoltaic unit travel different distances during the swivelling operation. Thus one end of the photovoltaic unit is lowered less towards the ground and the other end of the photovoltaic unit is lowered more towards the ground. With a suitable choice of swivelling axis it thus becomes possible that—owing to the angle of inclination in the setup position, at which one end is closer to the ground and the other end, owing to the angle of inclination, is located at a higher position above the ground—the end closer to the ground is lowered less towards the ground, whereas the end farther from the ground moves more towards the ground during swivelling. Thus, with a suitable choice of the adjusting axis, it is possible that at a maximum adjustment—at which the photovoltaic unit has the maximum elevation, and is located at its end position—both ends of the photovoltaic unit are at a substantially equal distance from the ground. As a result of this procedure, it becomes possible to achieve, with just a single-axis adjusting device, both a greater elevation and a greater azimuth than would be the case with a single-axis adjusting device in which the adjusting axis runs parallel to or along the setup axis. Thus a higher energy yield is made possible using a single-axis adjusting device, and savings are made on production costs compared with a two-axis adjusting device.

Further advantageous embodiments of the invention are defined in the dependent claims:

It has proved to be particularly advantageous if a second single-axis adjusting device is provided, which is designed in the same way as the first adjusting device, wherein the support part can be coupled alternately to the first adjusting device and to the second adjusting device and the swivelling ranges of the first adjusting device and of the second adjusting device are arranged as mirror images relative to the setup axis. By using a second single-axis adjusting device, the range in which the photovoltaic unit can track the position of the sun can essentially be doubled.

According to a preferred embodiment example, it can be envisaged that the drive device has a common drive for both adjusting devices. Using a single common drive for both adjusting devices can give savings on production costs. Through the selection of a suitable point of application for the drive device, preferably on the support part, it is possible for the two adjusting devices to be adjusted by a common drive without using an additional transmission system.

It can further preferably be envisaged that the drive of the drive device is a linear drive. Linear drives make precise adjustment of the support part by the drive device possible.

It has proved to be particularly advantageous if the linear drive of the drive device has at least one piston-cylinder unit. Piston-cylinder units provide an economical type of linear drives.

Particularly preferably, it can be envisaged that the support structure has at least one 3D-pivot joint, preferably a 3D-pivot bearing, for adjusting the support part. By using a 3D-pivot joint it becomes possible for this 3D-pivot joint to be used in common for both adjusting devices.

It has proved to be particularly advantageous if the support structure has a coupling device with corresponding coupling elements, by means of which the two adjusting devices can be coupled alternately to the support part. It is thus possible to ensure that in each case only one adjusting device is coupled to the support part.

According to a preferred embodiment example it can be envisaged that the support structure has a locking device with which the respective corresponding coupling elements of the coupling device can be locked and unlocked alternately. The use of a locking device ensures more reliable holding of the coupling device and of the support part.

It has further proved to be advantageous for the locking device to have a drive, preferably a linear drive, with which the respective corresponding coupling elements of the coupling device can be locked and unlocked alternately. By using a linear drive, locking and unlocking can take place automatically.

It has proved to be advantageous if a swivelling of the support part by means of the first adjusting device causes a raising of the support part of at least one coupling element of the second adjusting device and a swivelling of the support part by means of the second adjusting device causes a raising of the support part of at least one coupling element of the first adjusting device. Through detachment of the support part at one point of the adjusting device, swivelling by means of two adjusting devices that are not on the same axis becomes possible.

Preferably, it can further be envisaged that the support structure has at least two uprights, preferably of different lengths, on which the two adjusting devices, the 3D-pivot joint and at least two coupling elements of the coupling device are arranged, and a connecting and controlling device, wherein at least two coupling elements of the coupling device are arranged on one upright and/or the connecting and controlling device and/or the 3D-pivot joint are arranged on the other upright and/or one upright has an essentially triangular shape and/or one upright has an essentially quadrilateral shape and/or at least one, preferably both, uprights have at least one strut.

According to a possible embodiment example it can be envisaged that the at least one point at which the drive device drives the support part is at a distance from a point, preferably from all points, at which the adjusting device adjusts the support part. By means of a point of application offset from the rotation axis for the action of the force for swivelling the support part, and thus a photovoltaic unit mounted on the support part, it can become possible for a smaller expenditure of power to be necessary for adjustment and also for at least two adjusting devices to be operated with one drive device.

According to a preferred embodiment example it can be envisaged that the support structure has securing points for securing the photovoltaic unit, wherein the support structure can be folded flat. By folding flat, it is possible for several support structures to be stacked on one another. This means that less space is required during storage or transport.

It has proved to be particularly advantageous if, in the case of a support structure with a base structure, which can be embedded at least partially into the ground, and with a flat structure that can be embedded into the ground, and which in the assembled state is connected to the base structure in such a way that the forces, for securely anchoring the base structure in the ground, acting upon the flat structure due to the weight of the base material, can be transferred to the base structure, and the flat structure is flexible. Use of a flexible flat structure means that it can be either of folding or of roll-up design and thus requires less space during storage as well as during transport to the erection site. Flexible means in this context that the material of the flat structure is not rigid. Thus, the material of the flat structure has properties that are similar to a textile, a tarpaulin or a film, which allow their external shape to be altered very easily, for example rolled up, folded together etc., but can also be reformed from this state.

Protection is also desired for a stationary photovoltaic system with a support structure according to one of claims 1 to 14.

Further details and advantages of the present invention are explained in more detail below with the description of the figures and referring to the embodiment examples presented in the drawings, which show

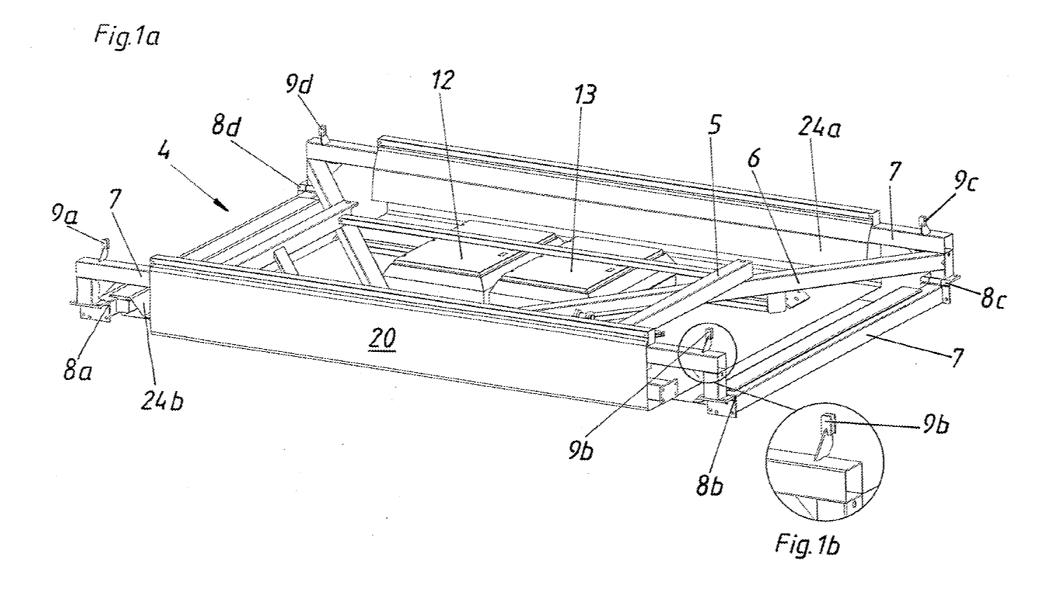

FIG. 1a a perspective view of a folded-up support structure,

FIG. 1b a detailed view of FIG. 1a,

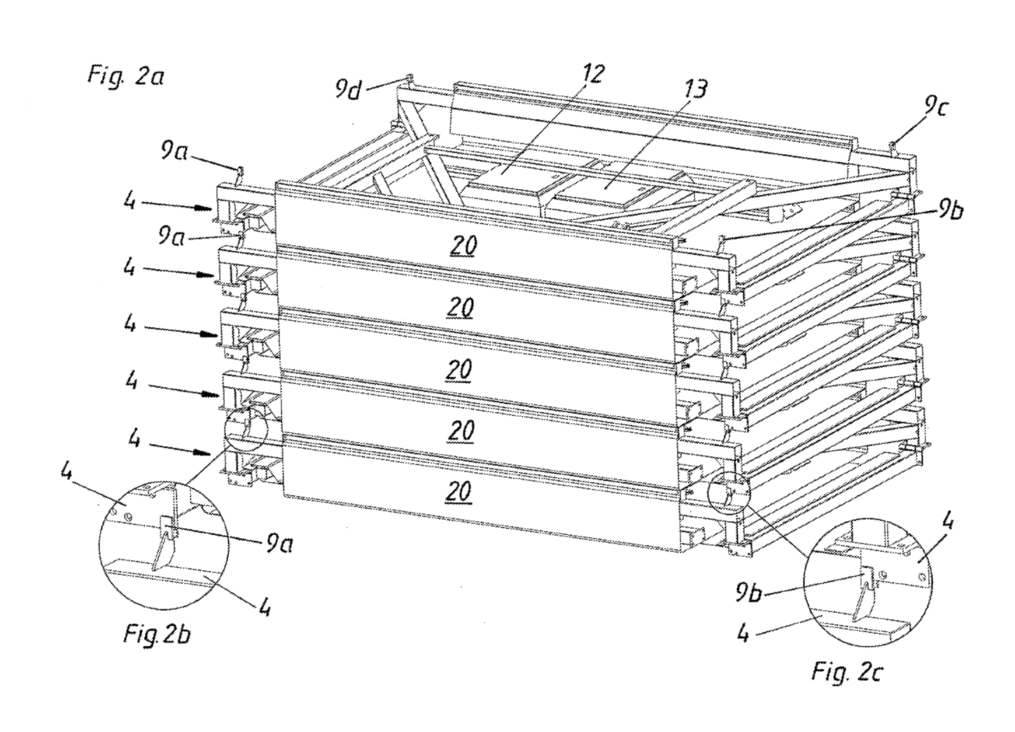

FIG. 2a a perspective view of several stacked support structures,

FIGS. 2b, 2c a detailed view of FIG. 2a,

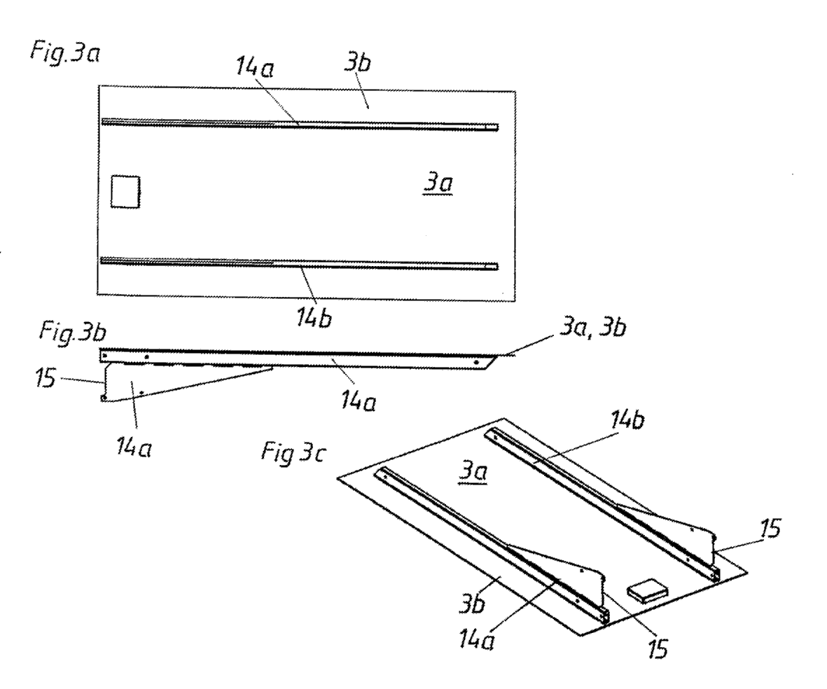

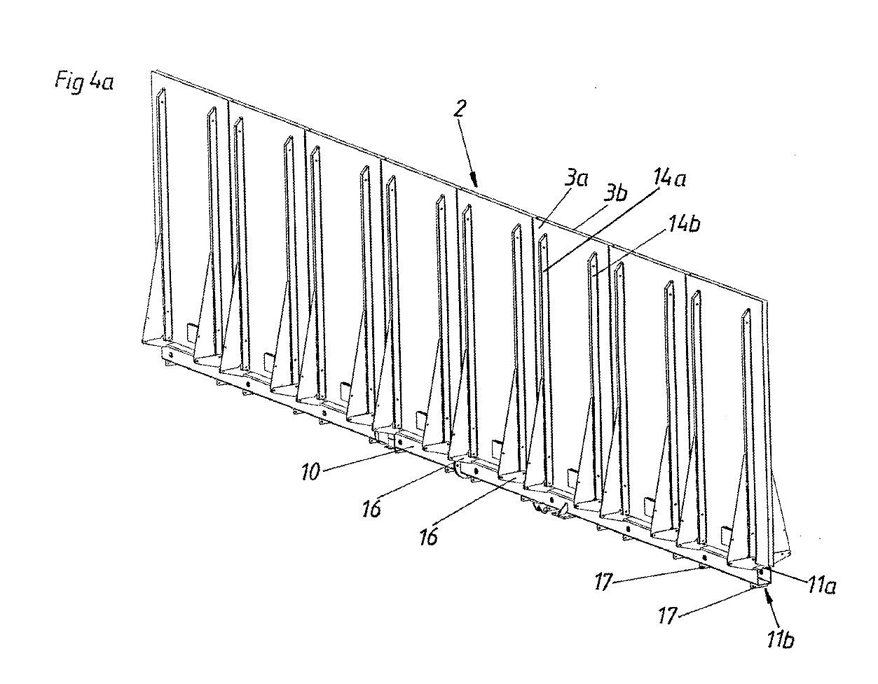

FIG. 3a a bottom view of a PV panel with holding devices,

FIG. 3b a front view of a PV panel with holding devices,

FIG. 3c a perspective view of a PV panel with holding devices,

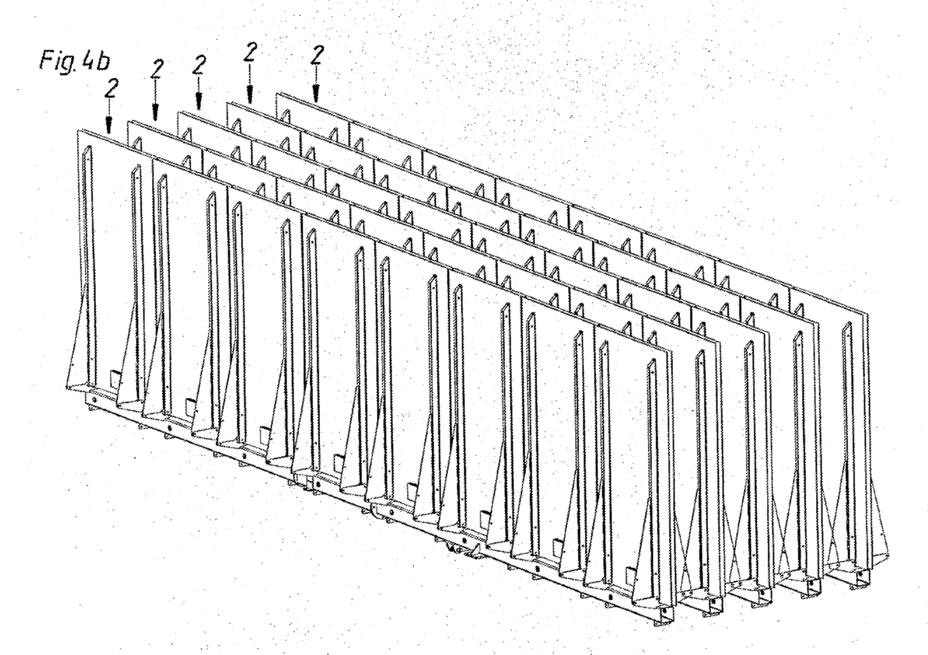

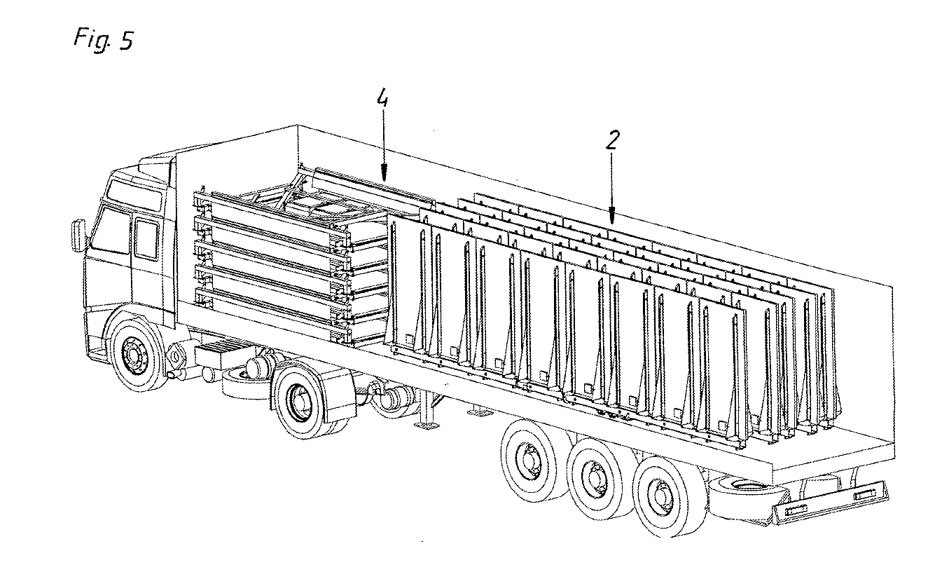

FIG. 4a a perspective view of a photovoltaic unit with several photovoltaic panels on a support in the folded-up state,

FIG. 4b several folded-up photovoltaic units side by side in perspective view,

FIG. 5 a perspective view of a transporter loaded with several support structures and several photovoltaic units,

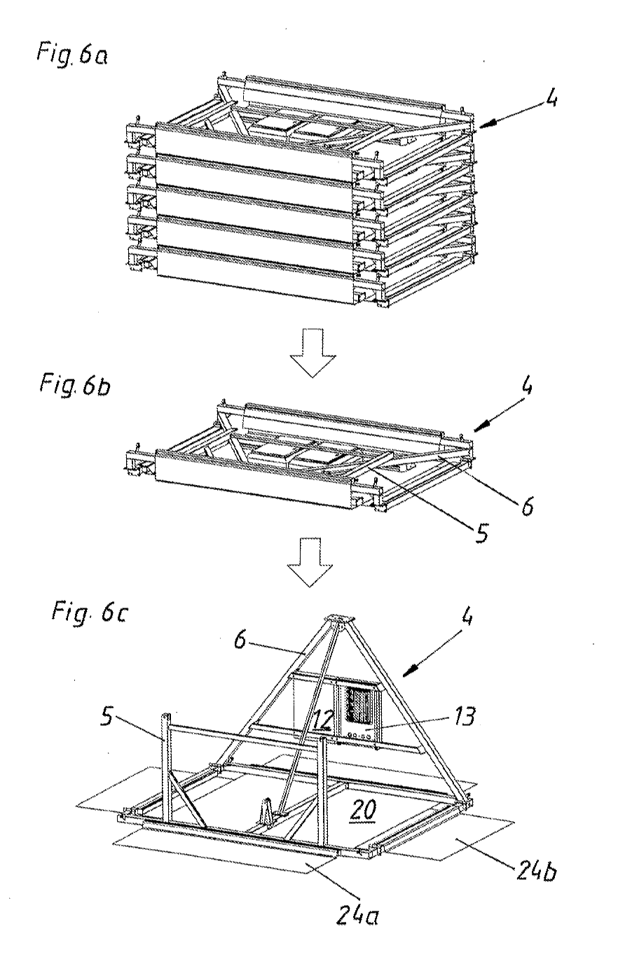

FIG. 6a to FIG. 6c unloading and erection of the support structure at the destination,

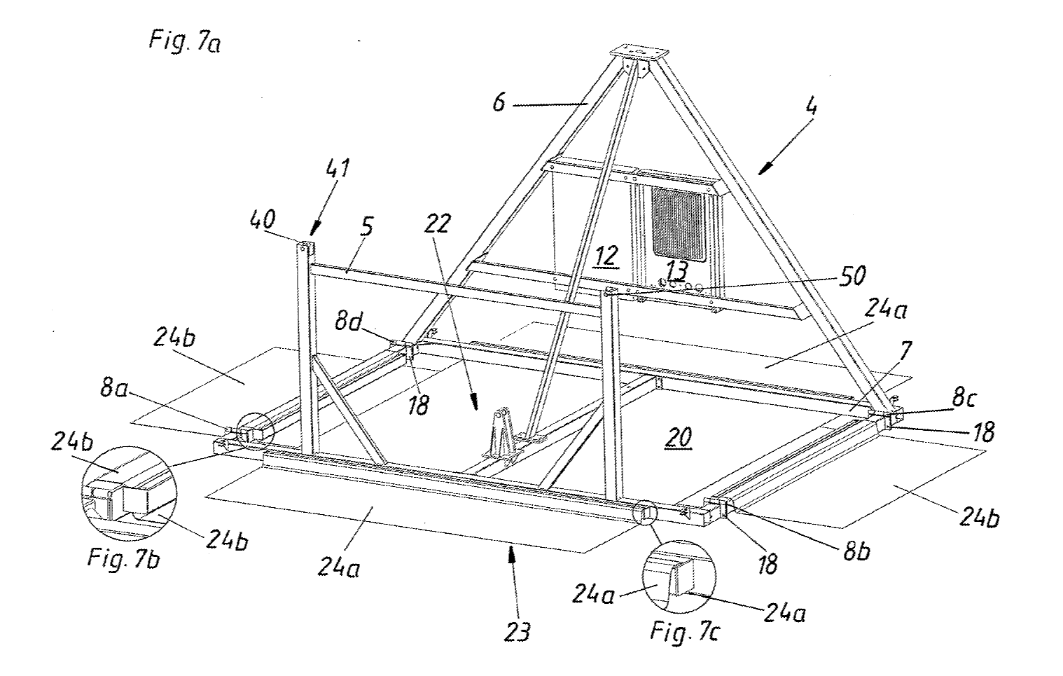

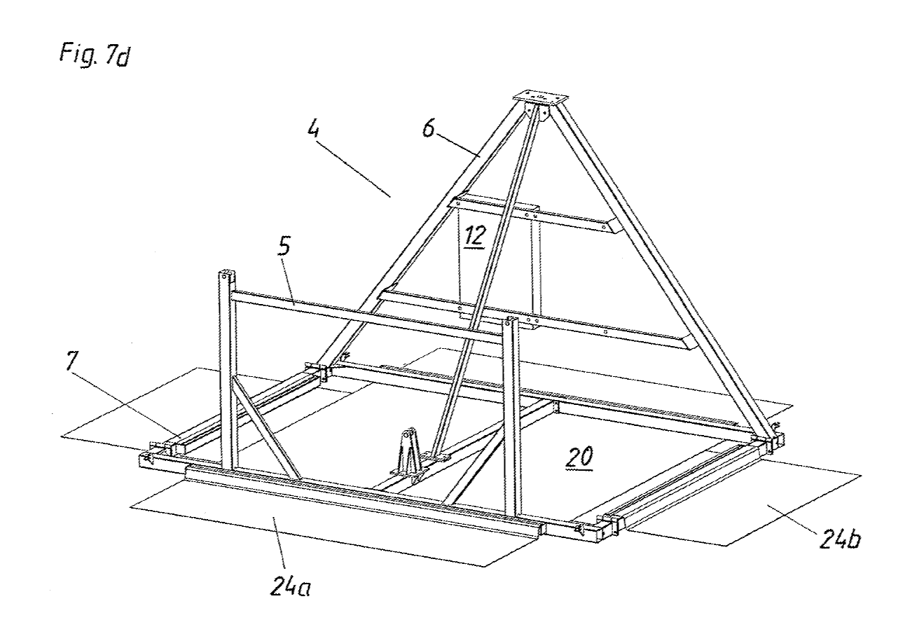

FIG. 7a and FIG. 7d a perspective view of an unfolded and erected support structure,

FIG. 7b and FIG. 7c a detailed view of FIG. 7a,

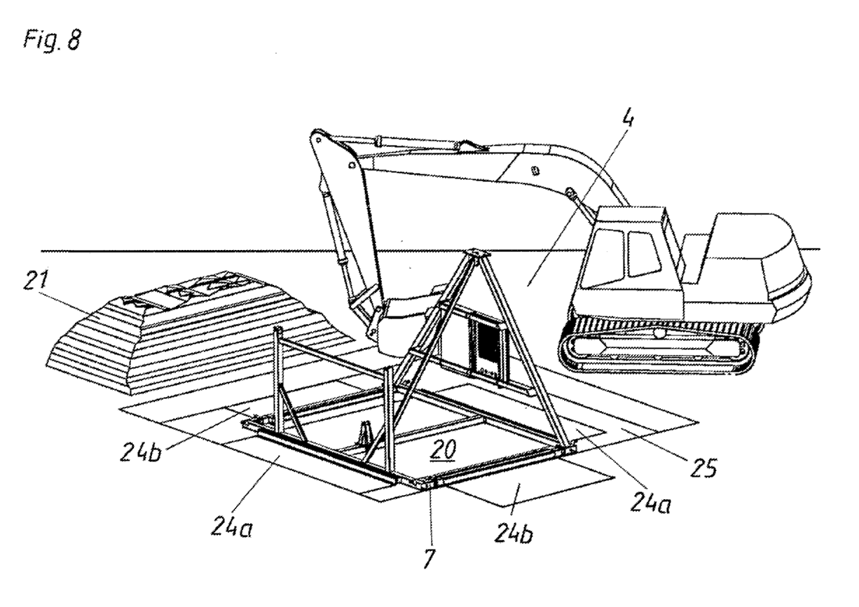

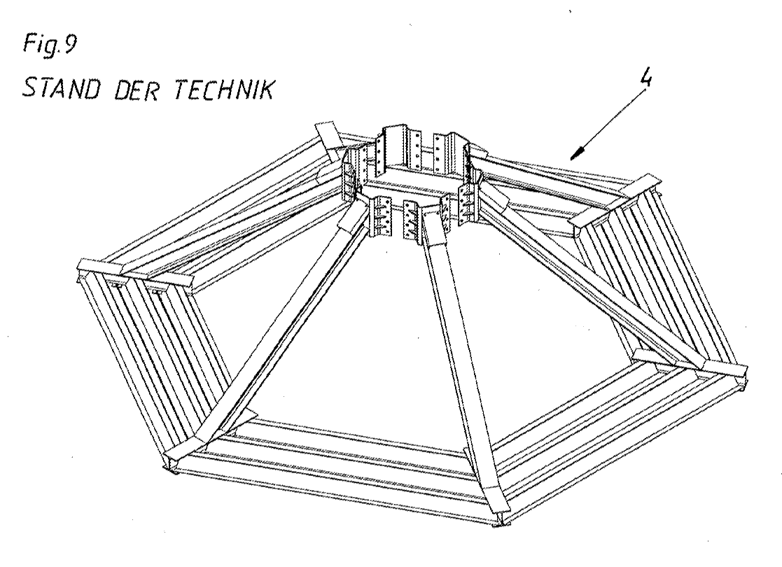

FIG. 8 a perspective view of an erected support structure in a foundation pit,

FIG. 9 a support structure according to the state of the art,

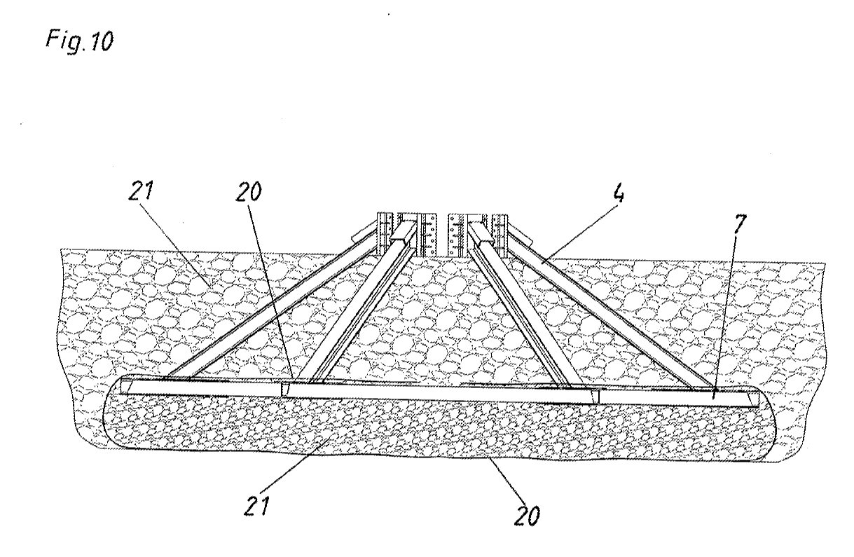

FIG. 10 a section through the soil and a support structure with a foundation with a flexible flat structure,

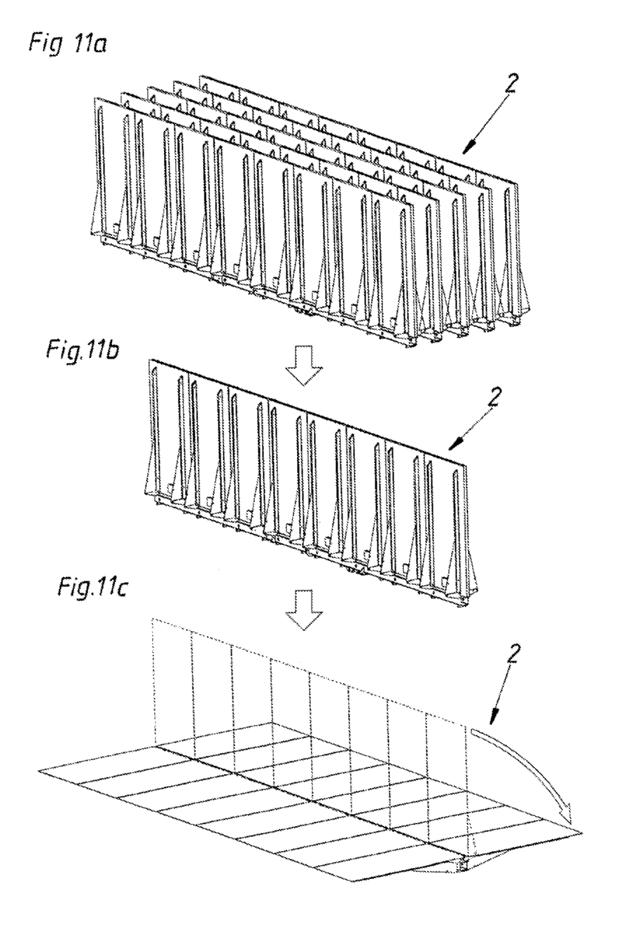

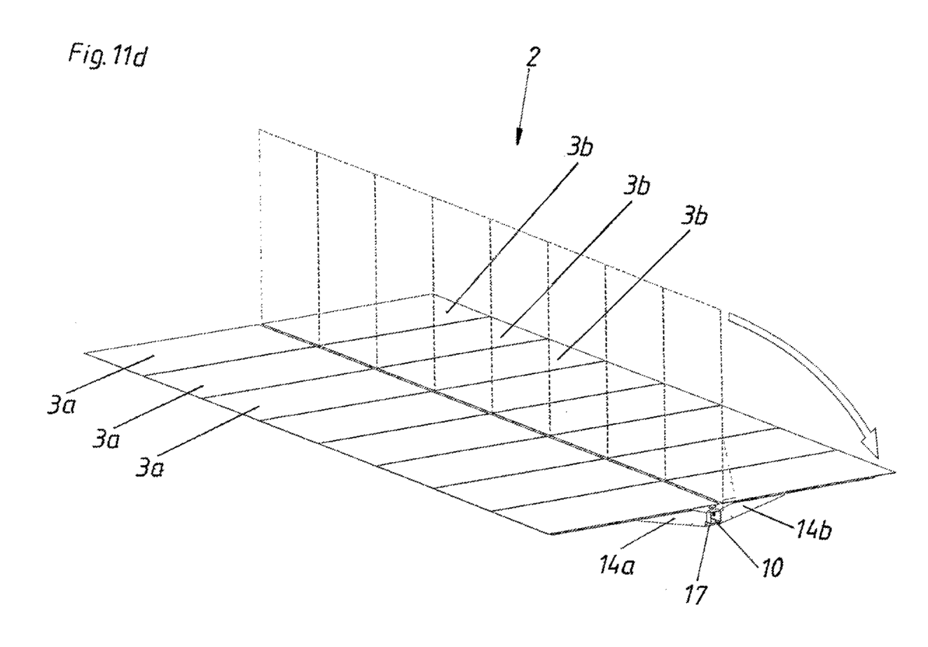

FIG. 11a to FIG. 11c unloading and unfolding of a photovoltaic unit at the destination in perspective view,

FIG. 11d a perspective view of an unfolded photovoltaic unit,

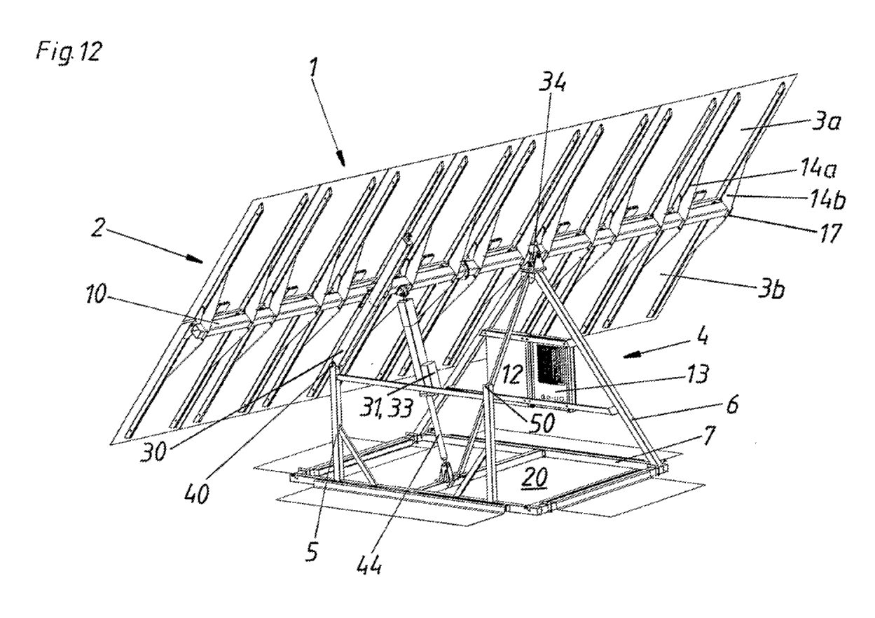

FIG. 12 a perspective view of a photovoltaic system,

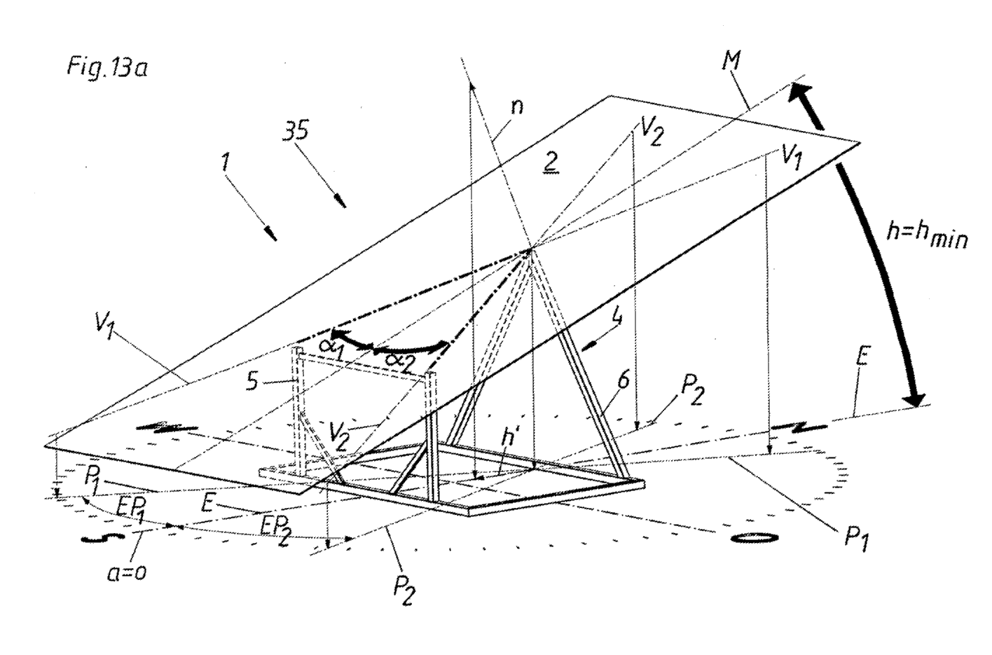

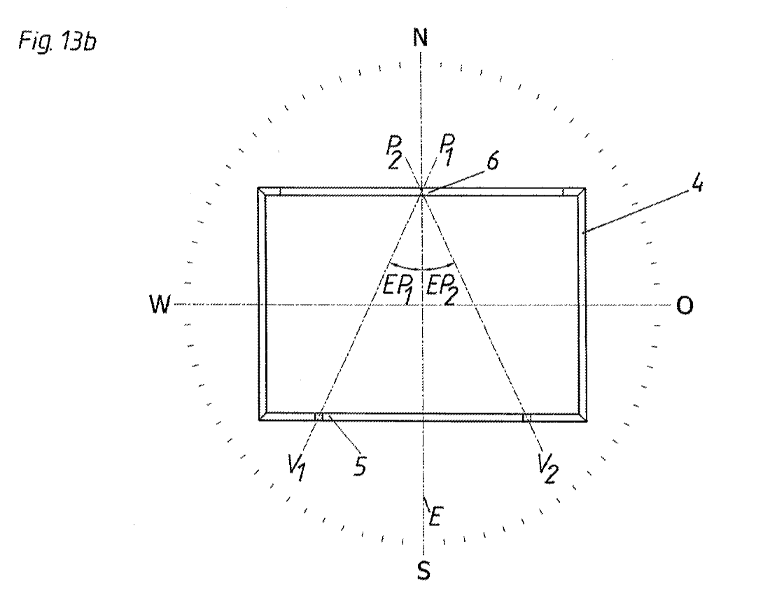

FIG. 13a a perspective view of a schematic stationary photovoltaic system,

FIG. 13b a top view of a schematic support structure of a stationary photovoltaic system,

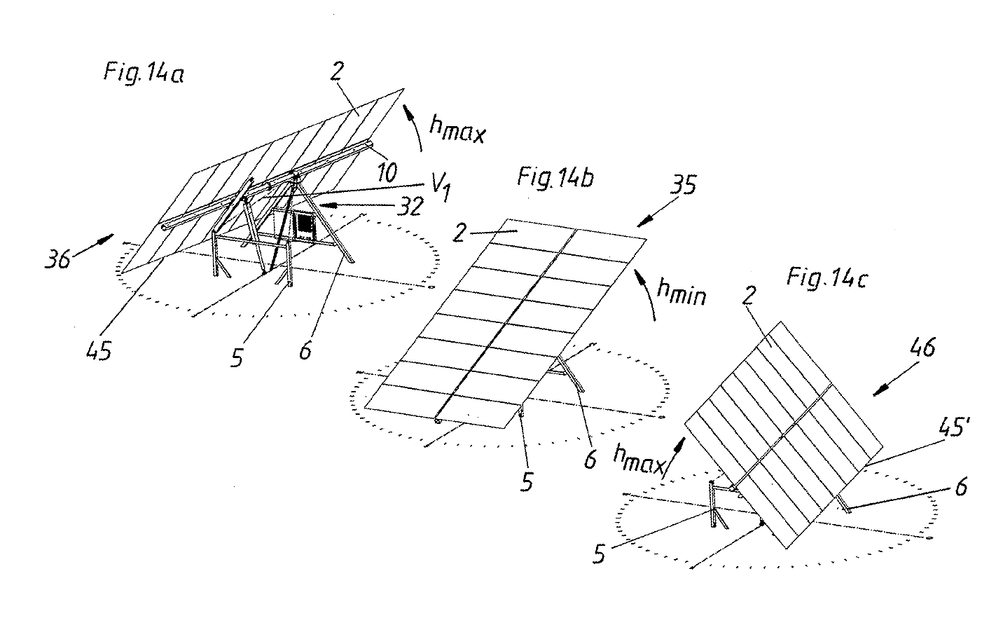

FIG. 14a to FIG. 14c perspective views of a photovoltaic system with different positions of the photovoltaic units,

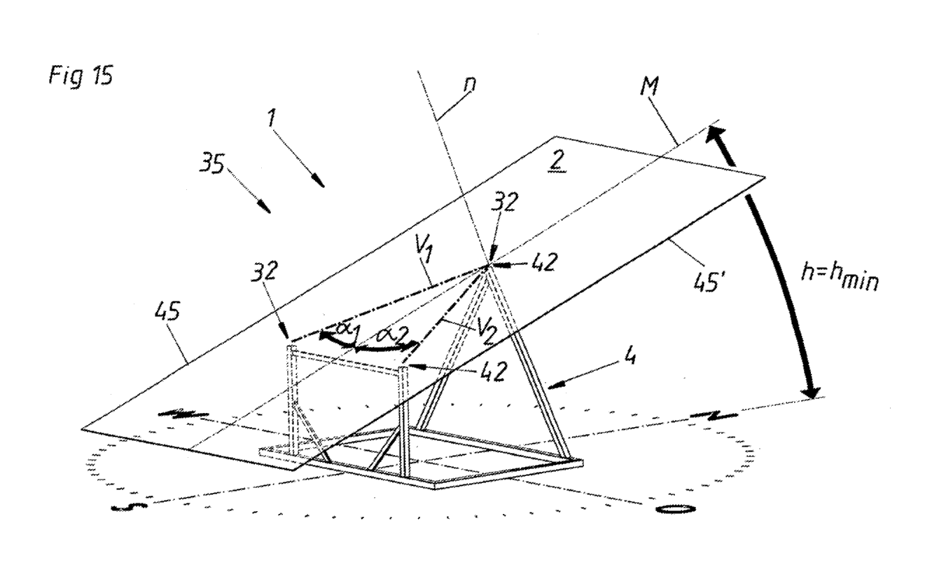

FIG. 15 a perspective view of a photovoltaic system with photovoltaic unit in the setup position (north-south orientation),

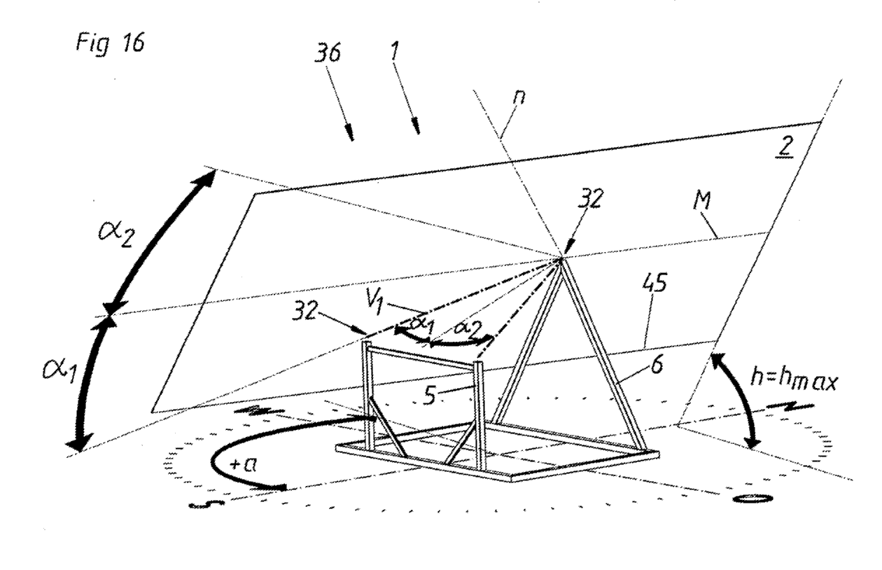

FIG. 16 a perspective view of a photovoltaic system with photovoltaic unit in the tilted position (westerly orientation),

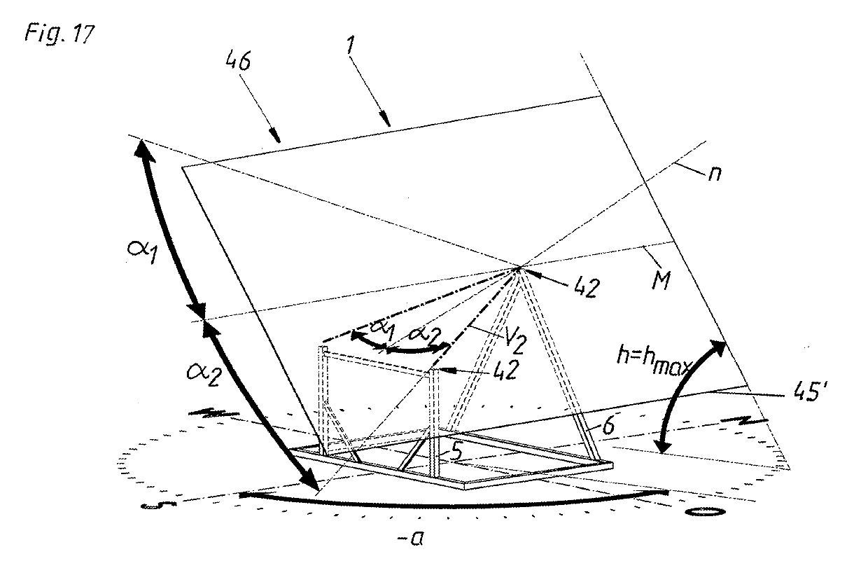

FIG. 17 photovoltaic system in perspective view with tilted photovoltaic unit (easterly orientation),

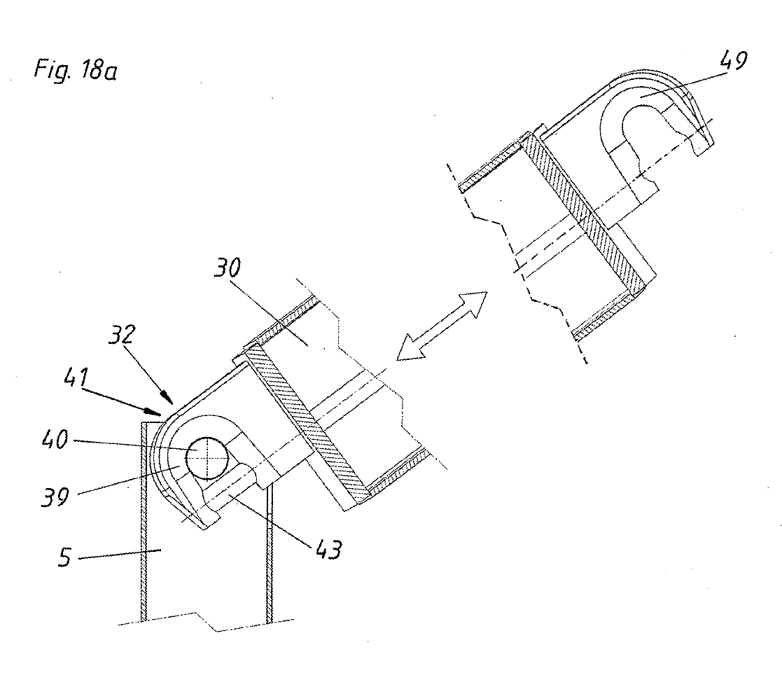

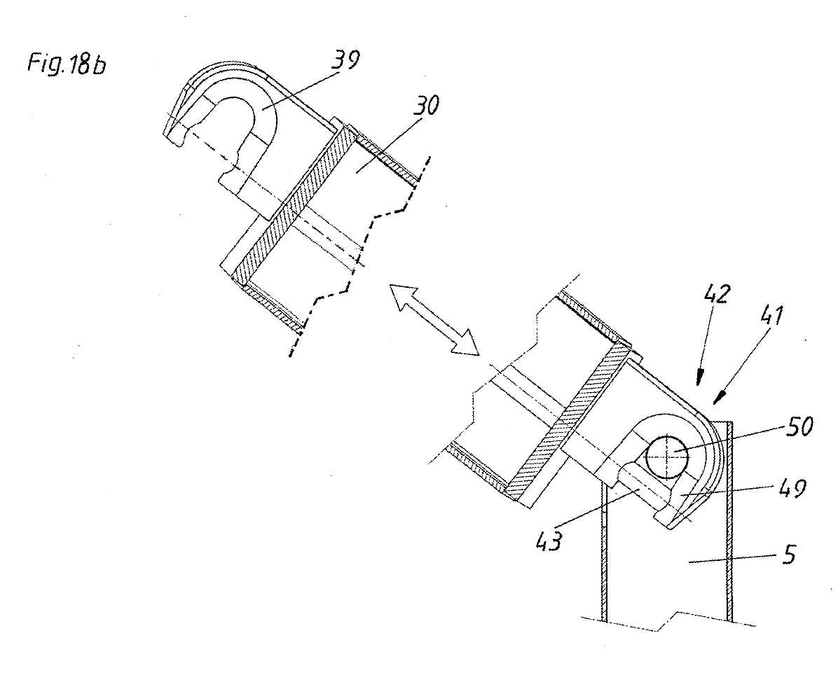

FIGS. 18a, 18b section through a coupling device of a support structure of a photovoltaic system,

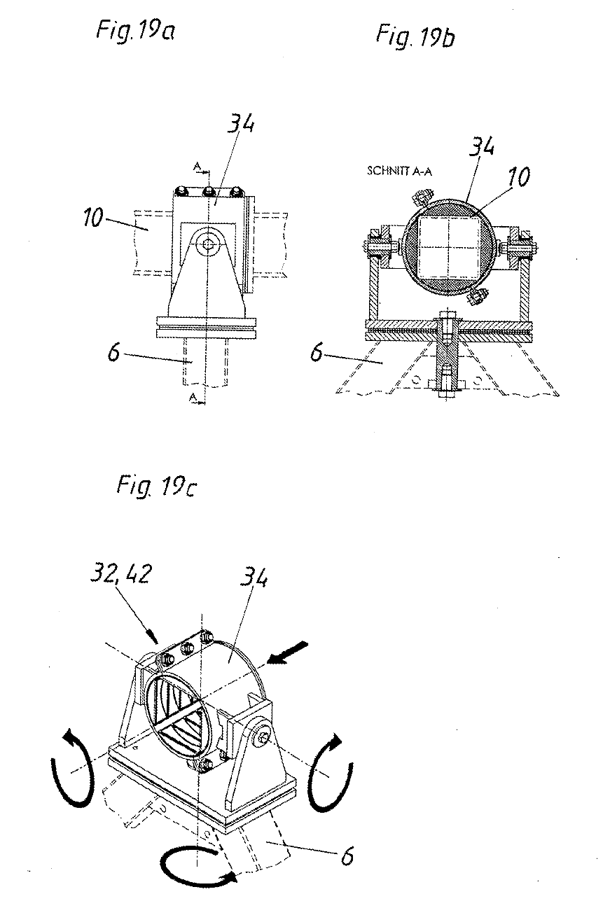

FIG. 19a a front view of a 3D-pivot bearing,

FIG. 19b section from FIG. 19a,

FIG. 19c perspective view of a 3D-pivot bearing of a photovoltaic system.

FIG. 1a shows a flat folded-up support structure 4 of a stationary photovoltaic system 1 (not shown). The two uprights 5 and 6 are in this case folded into the internal space of the base structure 7, resulting in a total height of the folded-up support structure 4 that is essentially defined by the height of the folded base structure 7. The folded base structure 7 and therefore also the two uprights 5 and 6 are swivelled by means of the hinges 8a, 8b, 8c, 8d. The flexible flat structure 20, in this embodiment example consisting of two strips 24a and 24b, is introduced, preferably threaded into the folded-up base structure 7. In another embodiment example it is envisaged to form the flat structure 20 in one piece. In this embodiment example the connecting and controlling device 12 and the inverter 13 are attached to upright 6 and are thus swivelled together with this in the swivelling operation.

The base structure 7 is designed as a frame, which leads to a very stable structure and by which the flexible flat structure 20, strictly speaking its strips 24a and 24b, can be implemented.

In this embodiment example, on the support structure 4, four connecting elements 9a, 9b, 9c, 9d are arranged, via which the folded-up support structure 4 can be connected, strictly speaking stacked, with another support structure 4.

FIG. 1b shows in detail a connecting element 9b, with which the support structure 4 can be connected to another support structure 4. It is of course also conceivable that these connecting elements 9a to 9d are not designed as individual components, but result from the form and shape of the base structure 7. The only thing that is decisive is that support structures 4 stacked on top of one another can be arranged without possibility of displacement and that they can retain their position during storage or transport. Thus during transport, no additional materials would be required for securing the support structure, which means little expenditure on materials for transport as well as little expenditure on packing materials. Naturally, the stacked support structures 4 can also be additionally secured, for example by means of a holding strap, to rule out any risk of slipping.

FIG. 2a shows five support structures 4 stacked on top of one another, which are connected to each other by the connecting elements 9a, 9b, 9c, 9d. The connecting elements 9c and 9d can only be seen in the topmost support structure 4, these are of course also present on all the other four support structures 4 and connection is made via these connecting elements 9a to 9d to the support structure 4 located above. The flexible flat structure is in each case enclosed in the support structures 4. The connecting and controlling devices 12 and at least one inverter 13 are also located inside the folded-up support structures 4. Several support structures 4 can thus be transported and/or stored while saving space.

FIG. 2b and FIG. 2c show in detail the connecting elements 9a and 9b, connected to a support structure 4 located above and fixing it in position.

FIG. 3a shows the underside of a photovoltaic panel 3a or also 3b, which in this embodiment example are provided with two glued-on holding devices 14a and 14b. Gluing-on of the holding device offers protection against theft, as the glued joint cannot be detached without damaging the photovoltaic panel 3a, 3b, or can only be detached with great difficulty—leaving residues of adhesive on the photovoltaic panel. In this embodiment example the holding devices 14a and 14b have a stop element 15, with which the position of the photovoltaic panel 3a, 3b in the unfolded state on the support 10 (not shown) is predetermined.

FIG. 4a shows a photovoltaic unit 2 in the folded-up state. In each case there are two photovoltaic panels 3a and 3b with their collecting surfaces folded towards one another, but not touching. On this photovoltaic unit 2, sixteen of these photovoltaic panels 3a and 3b are arranged in pairs on the support 10. These photovoltaic panels 3a and 3b are secured with holding devices 14a and 14b, which in turn can be fixed by means of the locking device 16 in their position in the folded-up state. Inserts further prevent contact between the photovoltaic panels (not shown). In the unfolded state (not shown) the holding devices 14a and 14b are connected to the locking device 17 and thus the photovoltaic panels 3a, 3b are fixed in their position. The arrangement of the photovoltaic panels 3a, 3b and their holding devices 14a and 14b takes place in this embodiment example on the lateral surface 11a of the support 10, whereby the opposite lateral surface 11b of the support 10 remains free and thus can be used for mounting the folded-up as well as unfolded photovoltaic unit 2. Thus no modifications are required in order to secure a folded-up photovoltaic unit 2 on a transporter.

FIG. 4b shows several folded-up photovoltaic units 2 placed next to one another, saving space.

FIG. 5 shows the loading of a lorry, with space for several support structures 4 and several photovoltaic units 2. The support structures 4 are stacked on top of one another without possibility of slipping and the photovoltaic units 2 can be mounted by means of the support 10 on the loading surface of the lorry without slipping or tipping. Thus, up to six stationary photovoltaic systems can be transported simultaneously on a commercially available lorry.

FIG. 6a shows five support structures 4 stacked on top of one another, from which it is then possible, as shown in FIG. 6b, to remove a support structure 4 and erect it at its destination, as shown in FIG. 6c. Then the uprights 5 and 6 are unfolded, simultaneously unfolding and stretching the flexible flat structure 20. The connecting and controlling device 12 and the inverter 13 are raised simultaneously together with the upright 6. The two uprights 5 and 6 are fixed in their upright position and can then receive the photovoltaic unit 2 (not shown).

FIG. 7a shows an unfolded support structure 4. The base structure 7 was unfolded by means of hinges 8a, 8b, 8c, 8d and forms a frame. Hinges 8a, 8b, 8c, 8d can be fixed in their position above the holes 18. Through the unfolding of the base structure 7, the two uprights 5 and 6 were also raised automatically and can now also be fixed in their position through the holes 18, for example by screwing.

Also through the unfolding of the base structure 7, the flexible flat structure 20 has been unfolded and thus has a base area 23 that is larger than the standing area 22 of the base structure 7. The standing area 22 of the base structure 7 is provided by the area covered by the frame, and the base area 23 of the flat structure 20 provided by the sum of the two strips 24a and 24b of the flat structure minus the area of one strip, where this covers the other strip. Because the base area 23 is greater than the standing area 22, a more stable anchoring of the support structure 4 in the ground becomes possible.

The two strips 24a, 24b of the flexible flat structure 20 are in this embodiment example passed through, strictly speaking threaded through, the struts of the base structure 7 (see FIG. 7b and FIG. 7c), which leads to automatic stretching of the flexible flat structure 20 during unfolding of the base structure 7. The flexible flat structure 20 is preferably designed to be water-permeable, to ensure that when it rains, etc. water can run away through the base structure 4, strictly speaking the flexible flat structure 20, and thus does not have an adverse effect on the stability of the base structure 7 in the ground.

Moreover, the coupling elements 40 and 50 of the coupling device 41 are arranged on the upright 5, and are provided for the swivelling of a photovoltaic unit that is not shown (see FIGS. 18a and 18b).

The inverter 13 and the connecting and controlling device 12 are arranged on the upright 6, whereby this support structure 4 can be operated as a “stand-alone system”, if it is equipped with a photovoltaic unit 2.

When erecting a photovoltaic power plant, consisting of several photovoltaic systems 1 (not shown), an inverter 13 is only required on one of the support structures 4, as shown in FIG. 7a. For the other photovoltaic systems 1 (not shown), a support structure 4 is required, as shown in FIG. 7d. The description for this is the same as for FIG. 7a, the only difference being that no inverter 13 (not shown) is required.

FIG. 8 shows a support structure 4, erected in a foundation pit 25. After completion of insertion and alignment of the support structure 4 and spreading out of the flexible flat structure 20, this can now be filled with material forming the foundation, preferably with the previously excavated base material 21. It would of course also have been possible to use other material that was not present at the erection site for filling, such as for instance sand, gravel, concrete, etc. The load of the base material 21 on the flat structure 20 and its strips 24a and 24b extending over the base structure 7 provides secure anchoring of the base structure 7 in the ground. Because the flat structure 20 is flexible, it can be folded up when transported and stretched out at the erection site through the unfolding of the base structure 7. Preferably, the material of the flexible flat structure 20 is designed to have good tensile strength in the longitudinal and transverse direction. It has been found that geoplastics are the most suitable for these tasks of foundation construction. Of course, any other flexible materials are also conceivable for this type of foundation.

Naturally, different support structures 4 are also suitable for this type of foundation of a photovoltaic system 1 (not shown). Thus, FIG. 9 shows another, different support structure 4 for this type of foundation. A flat structure 20 can also be introduced into such a support structure 4 and the method of foundation construction presented in FIG. 8 can be carried out.

FIG. 10 shows another variant of a possible method of anchoring a support structure 4 for a photovoltaic unit 2 of a stationary photovoltaic system 1 (not shown). In this, first of all base material 21 is excavated, thus forming a foundation pit 25. Then the flat structure 20 is introduced into the foundation pit 25 and partially filled with base material 21. In this embodiment example this base material is gravel, but of course any other material could also be used, as well as the excavated material from the foundation pit 25.

Then the base structure 7 is brought into the foundation pit 25 onto the partially filled flat structure 20. The ends of the flat structure 20 are laid over the base structure 7, thus the base material 21 that is located beneath the base structure 7 also contributes to the secure anchoring of the base structure 7. Then the foundation pit 25 is filled with base material 21. Here too, any other material is of course conceivable for filling the foundation pit 25.

After completion of anchoring of the base structure 7 and thus of the support structure 4 at the erection site, the photovoltaic unit 2, as shown in FIGS. 11a to 11c, can then be unloaded from a transporter and can be erected.

FIG. 11a shows five photovoltaic units 2 placed side by side and folded-up, which are for example on a lorry (not shown). One is now removed from the lorry (as shown in FIG. 11b) and is unfolded at its destination (as shown in FIG. 11c).

FIG. 11d shows an unfolded photovoltaic unit 2, consisting of sixteen photovoltaic panels 3a and 3b (for clarity, only six of the sixteen panels have been labelled). Panels 3a, 3b are fastened by means of holding devices 14a and 14b swivellably on the support 10. By swivelling-out the photovoltaic panels 3a, 3b, these are brought automatically into the correct position, as the holding devices 14a and 14b have a stop element 15 (not shown). In this unfolded position, the holding devices 14a and 14b, and with them the photovoltaic panels 3a and 3b, preferably connected by gluing, can be fixed in their position by means of the locking device 17. This ensures that even in adverse weather conditions, such as for instance a storm, the photovoltaic panels 3a, 3b are unchangeable in their position. The unfolding of the photovoltaic unit 2 for the first time normally takes place while it is mounted on the support structure 4 (not shown), as this helps to simplify the operation.

FIG. 12 shows a photovoltaic system 1, which has a photovoltaic unit 2 and a support structure 4. Moreover, a support part 30, a drive device 31 and a 3D-pivot bearing 34 are arranged between the photovoltaic unit 2 and the support structure 4, which serve to adjust or swivel the photovoltaic unit 2, in order to track the position of the sun. The connecting and controlling device 12 and the inverter 13 are arranged on the upright 6. Thus, this photovoltaic system 1 can serve as a “stand-alone photovoltaic power plant”. On the upright 6 there is the 3D-pivot bearing 34, about which, among other things, the photovoltaic unit 2 is swivelled. The adjusting devices 32 and 42 (not shown) for the photovoltaic unit 2 are formed from the 3D-pivot bearing 34 and the coupling elements 40 and 50 on the upright 5 and the coupling elements 39 and 49 on the support part 30 (not shown, cf. FIG. 18a and FIG. 18b).

In a preferred embodiment example, when erecting the photovoltaic system 1, the support structure 4 is first erected and unfolded. Then the support structure 4 is oriented and anchored in the ground. Next, the 3D-pivot bearing 34 is mounted on the upright 6. Now the photovoltaic unit 2 can be placed on the support structure 4 and secured to the support part 30 and to the 3D-pivot bearing 34. Then the drive device 31 can be connected to the support 10 of the photovoltaic unit 2.

The drive device 31 is equipped with a drive 33, which in this embodiment has a piston-cylinder unit 44. Both the single-axis adjusting device 32 and the single-axis adjusting device 42 can be actuated with this, preferably one, drive device 31.

The base structure 7 of the support structure 4 has in this case a flexible flat structure 20, with which the photovoltaic system 1 can be anchored in the ground.

The photovoltaic unit 2 consists, in this embodiment example, of eight photovoltaic panels 3a and eight photovoltaic panels 3b, which are arranged swivellably and essentially symmetrically on a support 10. The photovoltaic panels 3a and 3b have holding devices 14a and 14b, by means of which the photovoltaic panels 3a and 3b can be swivelled on the support 10. By means of the locking devices 17, the photovoltaic panels 3a, 3b can be fixed in their unfolded position.

FIG. 13a shows the schematic representation of a photovoltaic system 1 of a photovoltaic unit 2 on a support structure 4.

In general, photovoltaic systems 1 are set up in such a way that the collecting surface of the photovoltaic unit 2 is oriented towards the south. In solar technology, the deviation of the solar panel from south is designated as the azimuth a. Easterly orientation means minus 90°, south-easterly orientation means minus 45°, southerly orientation corresponds to 0°, plus 45° is south-westerly orientation and westerly orientation of the panel means plus 90°.

In FIG. 13a, the photovoltaic unit 2 is in its setup position 35, which is selected so that the photovoltaic unit 2 is oriented substantially towards the south and thus has an azimuth a=0. In this position (setup position 35), the photovoltaic unit 2 has its ideal angle of inclination. The angle of inclination is called elevation h in photovoltaic technology, and is thus the angle that the collecting surface of the photovoltaic unit 2 forms with the horizontal plane. This is found from the different heights of the two uprights 5 and 6 and the distance between the two uprights 5, 6. In the setup position 35, the photovoltaic system 1 thus preferably has an azimuth a=0 and an ideal elevation hₘᵢₙ—thus the ideal angle of inclination to the sun.

The various axes and the angles between the axes are explained below; the associated adjusting devices and other components will not be discussed and are not shown:

The adjusting axis V₁ of the adjusting device 32 runs essentially in the plane of the photovoltaic unit 2. This deviates from the imaginary central axis M of the photovoltaic unit 2 and forms an angle α₁ with it. The projection of the adjusting axis V₁ on the horizontal plane forms the projected adjusting axis P₁. The projection of the surface normal n of the photovoltaic unit 2 on the horizontal plane gives the projected surface normal n′. The prolongation of the projected surface normals n′ forms the setup axis E when the photovoltaic unit 2 is in the setup position 35, as shown here. The projected adjusting axis P₁ forms an angle EP₁ with the setup axis E. The angle EP₁ is thus the angle α₁ projected on the horizontal plane 1.

The adjusting axis V₂ of the adjusting device 42 runs essentially in the plane of the photovoltaic unit 2. This deviates from the imaginary central axis M of the photovoltaic unit 2 and forms an angle α₂ with it. The projection of the adjusting axis V₂ on the horizontal plane forms the projected adjusting axis P₂. The projection of the surface normal n of the photovoltaic unit 2 on the horizontal plane gives the projected surface normal n′. The prolongation of the projected surface normals n′ forms the setup axis E. The projected adjusting axis P₂ forms an angle EP₂ with the setup axis E. The angle EP₂ is thus the angle α₂ projected on the horizontal plane 1.

In a preferred embodiment example the elevation hₘᵢₙ in the setup position 35 is approx. 20°. The angle α₁ or α₂ is in practice selected between 20° and 30°, in a preferred embodiment example the angle α₁ or α₂ is approx. 24°. This value depends on the dimensions of the photovoltaic system 1 and can thus vary considerably. These values were determined in modelling experiments, but it would of course also be possible to calculate them.

FIG. 13b shows the top view of the support structure 4 of a photovoltaic system 1 (not shown). For greater clarity, the support structure 4 has only been shown schematically. For greater clarity, this figure omits the photovoltaic unit 2, as well as the setup position 35 and the two adjusting devices 32 and 42:

The support structure 4 is as a rule set up in such a way that the orientation of the support structure 4 is selected so that the setup axis E runs essentially north to south. The setup axis E is formed by the projection of the surface normal n of the photovoltaic unit 2 on the horizontal plane (in the setup position 35 of the photovoltaic unit 2, which occurs when the photovoltaic unit 2 has an ideal elevation hₘᵢₙ). This setup position 35 occurs in this embodiment example when the photovoltaic unit 2 is at rest in both adjusting devices 32 and 42. The front edge of the photovoltaic unit 2 is essentially normal to the southerly direction and runs essentially parallel to the horizontal plane.

The projection of the adjusting axis V₁ on the horizontal plane forms the projected adjusting axis P₁. This projected adjusting axis P₁ is in the same plane as the setup axis E but it runs neither in the setup axis E nor parallel to it, it intersects the setup axis E and forms an angle EP₁ with it, which in a preferred embodiment example is between 20° and 30°.

The projection of the adjusting axis V₂ on the horizontal plane forms the projected adjusting axis P₂. This projected adjusting axis P₂ is in the same plane as the setup axis E but it runs neither in the setup axis E nor parallel to it, it intersects the setup axis E and forms an angle EP₂ with it, which in a preferred embodiment example is between 20° and 30°.

The two adjusting axes V₁ and V₂ are, in a preferred embodiment example, essentially in one plane, preferably essentially in or parallel to the plane of the collecting surface of the photovoltaic unit 2. As a result, the swivelling about the two adjusting axes V₁ and V₂ is symmetrical to the setup position 35 and thus symmetrical to the setup axis E.

FIG. 14a shows the swivelling about the adjusting axis V₁ of the adjusting device 32. The swivelling of the photovoltaic unit 2 took place starting from the setup position 35, where the photovoltaic unit 2 has an ideal elevation hₘᵢₙ (FIG. 14b). After the maximum swivel, the photovoltaic unit 2 has the end position 36 with maximum elevation hₘₐₓ. The lateral edge 45 of the photovoltaic unit 2 is, in the end position 36, essentially parallel to the horizontal plane.

FIG. 14c shows a swivelling about the adjusting axis V₂ (not shown), wherein the photovoltaic unit 2 has the maximum elevation hₘₐₓ in the end position 46. The lateral edge 45′ of the photovoltaic unit 2 is essentially parallel to the horizontal plane.

Swivelling about the adjusting axis V₁ (towards the west, FIG. 14a):

Starting from the setup position 35 (FIG. 14b), in which the photovoltaic unit 2 is in the position in which it has the ideal elevation hₘᵢₙ, the photovoltaic unit 2 is swivelled about the adjusting axis V₁.

The value of the angle EP₁ depends among other things on the following factors:

The size and shape of the photovoltaic unit 2, the distance of the swivel points on the adjusting axis V₁ from the ground and how far the swivel points of the adjusting axis V₁ are away from the edges 45 of the photovoltaic unit 2 and its centre.

The closer a swivel point of the adjusting axis V₁ is arranged towards the lateral edge 45, 45′ of the photovoltaic unit 2, the less a tilted photovoltaic unit 2 at this point approaches the ground, and the farther away a swivel point of the adjusting axis V₁ is from the edge 45 of the photovoltaic unit 2, the more a tilted photovoltaic unit 2 approaches this point.

Assuming that, with a maximum swivelling of the photovoltaic unit 2 to be achieved, an end position 36 has been reached with the photovoltaic unit 2, in a preferred embodiment example it is envisaged that in this case the side 45 of the photovoltaic unit 2 next to the ground runs essentially parallel to the ground and is at a preferred distance of about half a metre from the ground. The dimensions of the photovoltaic unit 2 and the planned maximum elevation hₘₐₓ (which is reached in the end position 36) reveal the swivel points for the adjusting axis V₁ of the support structure 4 or of the adjusting device 32. These points also reveal the angle EP₁ (angle between the projection of the adjusting axis V₁ on the horizontal plane and the setup axis E).

An illustrative example: At a desired height of the upright 5 of 1 m (as well as a planned swivel point of the photovoltaic unit 2 at the same height) and a planned height above the ground of the lateral edge 45, 45′ of the photovoltaic unit 2 at maximum tilt of half a metre, a swivel point of the adjusting axis V₁ is to be arranged about half a metre within the lateral edge 45 of the photovoltaic unit 2. The second swivel point on the adjusting axis V₁ is to be arranged closer to the centre (most preferably, in the region of the centre) on the upright 6 that is raised relative to the upright 5, achieving the effect that the swivelling of the photovoltaic unit 2 about the swivel point on the upright 5 produces a smaller swivel distance of the photovoltaic unit 2 relative to the ground and the swivelling of the photovoltaic unit 2 about the swivel point on the upright 6 produces a larger swivel distance, with the result that the lateral edge 45 of the photovoltaic unit 2 travels paths of different length towards the ground.

Thus both the advantage and the technical effect of this offset adjusting axis V₁ become clear. Because the swivelling of the photovoltaic unit 2 about the adjusting axis V₁ does not take place symmetrically, there is the desired effect that the photovoltaic unit 2—which has an inclination (elevation h) and thus in one region is closer to the ground—during swivelling in the region that is closer to the ground, approaches the ground less than it would during swivelling about an adjusting axis that lies along, parallel to or near the setup axis E or the imaginary central axis M of the photovoltaic unit 2 (such as for instance in the case of a photovoltaic system in which the adjusting axis would run along the support 10).

According to the state of the art—transferred to this embodiment example—the projected adjusting axis P₁ would run along the setup axis E and if the heights of the uprights 5 and 6 are made to be identical, a smaller swivelling of the photovoltaic unit 2 would produce ground contact in the front region. Thus, to achieve the same elevation h, either the shape of the photovoltaic unit 2 in the front region would have to be altered (made narrower), which would lead to a smaller power yield—or the uprights 5 and 6 would have to be made higher, which would make the photovoltaic system more susceptible to environmental effects (storm).

Swivelling about the adjusting axis V₂ (towards the east, FIG. 14c):

To achieve a type of swivelling also towards the east that is preferred in this way, a second adjusting axis V₂ is provided, which is preferably arranged as a mirror image. Swivelling about the adjusting axis V₂ proceeds correspondingly in the same way as described for adjusting axis V₁ and with correspondingly identical effects.

FIG. 15 shows the schematic representation of a photovoltaic system 1 with a photovoltaic unit 2 and a support structure 4. The photovoltaic system 1 has two adjusting devices 32 and 42, by means of which the photovoltaic unit 2 can be tilted. The adjusting axis V₁ is formed by the adjusting device 32. The adjusting axis V₂ is formed by the adjusting device 42. These adjusting axes V₁ and V₂ each form an angle α₁, α₂ with an imaginary central axis M of the photovoltaic unit 2. In this embodiment example the photovoltaic unit 2 is in its setup position 35, which is obtained when the photovoltaic unit 2 has the ideal elevation hₘᵢₙ relative to the sun. Normally, as also shown in this example, the photovoltaic system 1 is in the setup position 35, which is to be regarded as the base position and normally is selected so that this occurs when the photovoltaic system 1, strictly speaking the photovoltaic unit 2, is oriented in the north-south direction and has an azimuth a=0 (according to the definition). The lateral edges 45, 45′ of the photovoltaic unit 2 are inclined at the angle of the elevation hₘᵢₙ to the horizontal plane.

A swivelling of the photovoltaic unit 2 about the adjusting axis V₁ brings about, as shown in this example, a swivelling of the photovoltaic unit 2 towards the west (see FIG. 16). A swivelling about the adjusting axis V₂ brings about a swivelling of the photovoltaic unit 2 towards the east (see FIG. 17).

FIG. 16 shows a photovoltaic system 1, in which the photovoltaic unit 2 is in its end position 36. It reached this end position 36 through a swivelling of the adjusting device 32 about the adjusting axis V₁ towards the west. In this position the photovoltaic unit 2 has the maximum elevation hₘₐₓ and a maximum positive azimuth a. Because the adjusting axis V₁ is not parallel to or in the imaginary central axis M of the photovoltaic unit 2 but forms an angle α₁ with it, swivelling takes place in the rearward region, above the upright 6, to a much greater extent than in the front region, above the upright 5. As a result, the photovoltaic unit 2 now has, in its end position 36, a lateral edge 45 that runs essentially parallel to the horizontal plane.

FIG. 17 shows a photovoltaic system 1, in which the photovoltaic unit 2 has been swivelled about the adjusting axis V₂ of the adjusting device 42 towards the east. The photovoltaic unit 2 is now in its end position 46, in which it has the maximum elevation hₘₐₓ and a maximum negative azimuth −a. Because the adjusting axis V₂ is not parallel to or in the imaginary central axis M of the photovoltaic unit 2 but forms an angle α₂ with it, swivelling takes place in the rearward region, above the upright 6, to a much greater extent than in the front region, above the upright 5. As a result, the photovoltaic unit 2 now has, in its end position 46, a lateral edge 45′, which runs essentially parallel to the horizontal plane.

FIG. 18a shows the support part 30, which has securing points for the preferably flat photovoltaic unit 2 (not shown). A portion of the adjusting device 32 that is located on the upright 5 has in this case a coupling element 40 of the coupling device 41. The support part 30 has a coupling element 39 of the coupling device 41. The two coupling elements 39 and 40 have in this case been joined together and are locked by the locking device 43 and thus cannot be separated from one another. They can, however, be twisted towards one another, so that swivelling can take place by means of the adjusting device 32 and by means of the two coupling elements 39 and 40. The coupling element 49 is arranged at the other end of the support part 30, and at this point in time is not coupled to the coupling element 50 of the upright 5 (not shown).

FIG. 18b shows the adjustment for the adjusting device 42, wherein the two coupling elements 49 and 50 of the coupling device 41 are joined together and have been locked by the locking device 43. The coupling element 39 is arranged at the other end of the support part 30, and it can be seen that at this point in time the locking device 43 does not project into the region of the coupling element 39.

The locking by the locking device 43 always takes place just on one side of the support part, i.e. a swivelling can always only take place by means of the adjusting device 32 or by means of the adjusting device 42.

FIGS. 19a to 19c show a 3D-pivot bearing, about which the support 10 and thus the photovoltaic unit 2 (not shown) can be swivelled by means of the adjusting devices 32 and 42.

This three-dimensionally swivellable, maintenance-free bearing serves for positive mounting of the support 10, which as a support part for the photovoltaic unit 2 is moved into different positions depending on the sun's trajectory. In this embodiment example, the bearing 34 consists of galvanized, welded and screwed steel parts and is produced with sintered-bronze bushes and POM plastics in conjunction with special-steel bolts. On the first rotation axis the support 10 is mounted positively and rotatably by four bearing shells made of POM. The axial forces that develop are received by a flange welded onto the support 10 and by POM disks arranged between support 10 and bearing 34. The 3D-pivot bearing 34 is in two parts and for assembly is screwed onto the support 10 and the bearing shells are inserted. On the second rotation axis, the swivelling motion takes place by means of two sintered-bronze flange bushes. The flange bushes are pressed into the welded-on pillow blocks and the 3D-pivot bearing 34 is mounted with special-steel bolts and disks with sufficient axial clearance.

The rotary motion of the third axis takes place via a guide pin made of special steel, which serves simultaneously as connection between 3D-bearing 34 and support structure 4 (in this case the upright 6 of support structure 4). Two POM disks, which are inserted between the flange plates of the 3D-bearing 34 and the upright 6, act as sliding bearings.

Although the invention has been described concretely on the basis of the embodiment example shown, obviously the subject of the application is not limited to this embodiment example. Rather, it is obvious that measures and modifications for implementing the ideas of the invention are entirely conceivable and desirable.

### LIST OF REFERENCE SYMBOLS

1 photovoltaic system
2 photovoltaic unit
3a, 3b photovoltaic panel
4 support structure
5, 6 uprights
7 base structure
8a,8b, 8c,8d hinges
9a, 9b, 9c, 9d connecting elements
10 support
11a, 11b lateral surfaces of support 10
12 connecting and controlling device
13 inverter
14a, 14b holding device
15 stop element
16 locking device, folded-up
17 locking device, unfolded
18 hole
20 flat structure
21 base material
22 standing area of base structure 7
23 base area of flat structure 20
24a, 24b strips of flat structure 20
25 foundation pit
30 support part
31 drive device
32, 42 adjusting device
33 drive of drive device 31
34 3D-pivot bearing
35 setup position
36, 46 end position
39, 40, 49, 50 coupling element
41 coupling device
43 locking device
44 piston-cylinder unit of drive 33 of drive device 31
45, 45′ lateral edges of photovoltaic unit 2
a azimuth
h elevation
hₘᵢₙ ideal elevation relative to the sun
hₘₐₓ maximum elevation
V₁, V₂ adjusting axes
E setup axis
P₁, P₂ projected adjusting axes V₁, V₂ on the horizontal plane
EP₁ angle of setup axis E to the projected adjusting axis P₁
EP₂ angle of setup axis E to the projected adjusting axis P₂
α₁ angle of the imaginary central axis of the photovoltaic unit 2 to the adjusting axis V₁
α₂ angle of the imaginary central axis of the photovoltaic unit 2 to the adjusting axis V₂
M imaginary central axis of the photovoltaic unit 2
n surface normal of the photovoltaic unit 2
n′ projected surface normal n of the photovoltaic unit 2 on the horizontal plane

1. A device, comprising
a support structure for a stationary photovoltaic system, with:
a support part, which has securing points for a flat photovoltaic unit,
at least one drive device for driven adjustment of the support part,
at least one single-axis adjusting device, by means of which a photovoltaic unit fastened on the support part can be adjusted in azimuth and elevation about an adjusting axis between a setup position and an end position, wherein the projection of the surface normals of the photovoltaic unit on the horizontal plane in the setup position defines a setup axis and the projection of the adjusting axis on the horizontal plane defines a projected adjusting axis,
wherein the projected adjusting axis forms an angle with the setup axis in the range of more than 5 degrees and less than 80 degrees.

2. The device as claimed in claim 1, wherein the projected adjusting axis forms an angle with the setup axis in the range of more than 10 degrees and less than 60 degrees.

3. The device as claimed in claim 1, wherein a second single-axis adjusting device is provided, which is of the same design as the first adjusting device, wherein the support part can be coupled alternately to the first adjusting device and to the second adjusting device and the swivelling ranges of the first adjusting device and of the second adjusting device relative to the setup axis are arranged as mirror images.

4. The device as claimed in claim 3, wherein the drive device has a common drive for both adjusting devices.

5. The device as claimed in claim 4, wherein the drive of the drive device is a linear drive.

6. The device as claimed in claim 5, wherein the linear drive of the drive device has at least one piston-cylinder unit.

7. The device as claimed in claim 1, wherein the support structure has at least one 3D-pivot joint, preferably a 3D-pivot bearing, for adjusting the support part.

8. The device as claimed in claim 3, wherein the support structure has a coupling device with corresponding coupling elements by means of which the two adjusting devices can be coupled alternately to the support part.

9. The device as claimed in claim 8, wherein the support structure has a locking device, with which the respective corresponding coupling elements of the coupling device can be locked and unlocked alternately.

10. The device as claimed in claim 9, wherein the locking device has a drive with which the respective corresponding coupling elements of the coupling device can be locked and unlocked alternately.

11. The device as claimed in claim 10, wherein the drive of the locking device is a linear drive.

12. The device as claimed in claim 8, wherein a swivelling of the support part by means of the first adjusting device causes a raising of the support part of at least one coupling element of the second adjusting device and a swivelling of the support part by means of the second adjusting device causes a raising of the support part of at least one coupling element of the first adjusting device.

13. The device as claimed in claim 8, wherein the support structure has:
at least two uprights on which the two adjusting devices, the 3D-pivot joint and at least two coupling elements of the coupling device are arranged,
a connecting and controlling device,
wherein at least two coupling elements of the coupling device are arranged on one upright and/or the connecting and controlling device and/or the 3D-pivot joint are arranged on the other upright and/or one upright has an essentially triangular shape and/or one upright has an essentially quadrilateral shape and/or at least one upright has at least one strut.

14. The device as claimed in claim 13, wherein the at least two uprights are of different lengths.

15. The device as claimed in claim 13, wherein both uprights have at least one strut.

16. The device as claimed in claim 1, wherein the at least one point at which the drive device drives the support part is at a distance from a point, preferably from all points, at which the adjusting device adjusts the support part.

17. The device as claimed in claim 1, wherein the at least one point at which the drive device drives the support part is at a distance from all points at which the adjusting device adjusts the support part.

18. A device, comprising
a support structure for a stationary photovoltaic system, wherein the support structure has securing points for securing the photovoltaic unit, wherein the support structure can be folded flat.

19. A device, comprising
a support structure for a stationary photovoltaic system, with:
a base structure, which can be at least partially embedded into the ground,
a flat structure that can be embedded into the ground, and which in the assembled state is connected to the base structure in such a way that the forces, for securely anchoring of the base structure in the ground, acting upon the flat structure due to the weight of the base material can be transferred to the base structure,
wherein the flat structure is flexible.

20. The device as claimed in claim 19, wherein the flat structure is water-permeable.

21. The device as claimed in claim 19, wherein the flat structure is formed at least partially from a material that has good tensile strength at least in one direction.

22. The device as claimed in claim 19, wherein the flat structure is formed at least partially from a material that has good tensile strength in the longitudinal and transverse direction.

23. The device as claimed in claim 19, wherein the flat structure is formed substantially completely from a material that has good tensile strength at least in one direction.

24. The device as claimed in claim 19, wherein the flat structure is formed substantially completely from a material that has good tensile strength in the longitudinal and transverse direction.

25. The device as claimed in claim 19, wherein the flat structure is formed at least partially from geoplastic.

26. The device as claimed in claim 19, wherein the flat structure is formed substantially completely from geoplastic.

27. The device as claimed in claim 19, wherein the flat structure is formed at least partially from a geocomposite, wherein one of the composites is in the form of nonwoven fabric.

28. The device as claimed in claim 19, wherein the flat structure is formed substantially completely from a geocomposite, wherein one of the composites is in the form of nonwoven fabric.

29. The device as claimed in claim 19, wherein the base structure extends over an imaginary standing area and the flat structure has a base area, wherein the base area of the flat structure is larger than the standing area of the base structure.

30. The device as claimed in claim 19, wherein the support structure is configured so that it can be folded and unfolded.

31. The device as claimed in claim 30, wherein the flat structure is connected to the folded-up support structure.

32. The device as claimed in claim 30, wherein the flat structure is connected to the unfolded support structure.

33. The device as claimed in claim 30, wherein the flat structure is folded in the folded-up support structure and is stretched out during unfolding of the support structure.

34. The device as claimed in claim 19, wherein the flat structure is formed in one piece.

35. The device as claimed in claim 19, wherein the flat structure is formed from at least two strips.

36. A method of anchoring the device as claimed in claim 19, wherein
base material is excavated, thus forming a foundation pit, and
simultaneously or successively, the flat structure and the base structure are introduced into the foundation pit, and
the base material is placed on the flat structure and the foundation pit is filled up.

37. A method of anchoring the device as claimed in claim 19, wherein
base material is excavated, thus forming a foundation pit, and
the flat structure is introduced into the foundation pit and is partially filled with base material, and
the base structure is introduced into the foundation pit on top of the flat structure and the backfilled base material, and
the flat structure, preferably the ends of the flat structure, are connected to the base structure, preferably by overlapping, and
the foundation pit is filled up with the base material.

38. A stationary photovoltaic system with the device as claimed in claim 1.

39. A stationary photovoltaic system with the device as claimed in claim 18.

40. A stationary photovoltaic system with the device as claimed in claim 19.

41. A stationary photovoltaic system erected as claimed in a method of anchoring the device as claimed in claim 36.

42. A stationary photovoltaic system erected as claimed in a method of anchoring the device as claimed in claim 37.
